(19) United States
(12) Patent Application Publication
(10) Pub. No.: US 2017/0034263 A1
(43) Pub. Date: Feb. 2, 2017

(54) Synchronized Playback of Streamed Audio Content by Multiple Internet-Capable Portable Devices

(71) Applicant: Amp Me Inc., Montréal (CA)

(72) Inventors: Martin-Luc Archambault, Montréal (CA); André-Philippe Paquet, Montréal (CA); Nicolas Presseault, Lévis (CA); Marcos Paulo Damasceno, Montréal (CA); Julien Gobeil Simard, Québec (CA); Luc Bernard, Québec (CA); Martin Gagnon, Lévis (CA); Steve Matte, Québec (CA); Daniel Levesque, Lévis (CA)

(21) Appl. No.: 15/222,297

(22) Filed: Jul. 28, 2016

Related U.S. Application Data
(60) Provisional application No. 62/199,121, filed on Jul. 30, 2015.

(51) Int. Cl. H04L 29/08; G10L 21/055; H04R 29/00; H04L 29/06; G06F 3/16

(52) U.S. Cl. CPC H04L 67/1095; H04L 65/60; G06F 3/165; H04R 29/001; G10L 21/055

(57) ABSTRACT

Playback of an audio stream is synchronized on multiple connected digital devices by using synchronization fingerprints. Playback actions may furthermore be synchronized on all devices, such as skips and pauses. Furthermore, synchronization may be maintained even in the presence of variations in decoding speed, playback interruptions, and network disconnections. Synchronized playback of streamed audio content on multiple devices is achieved by devices compensating for time drifting induced by network instability and variable playback speed across master and guest devices to reduce the formation of echoes during playback.

### RELATED APPLICATIONS

This application claims the benefit of U.S. Provisional Application No. 62/199,121 filed on Jul. 30, 2015, the content of which is incorporated by reference herein.

### BACKGROUND

Technical Field

The present disclosure relates to synchronized playback of cloud-based audio content from a plurality of internet-capable digital devices.

Description of Related Art

Internet-capable digital devices such as mobile phones, tablets and laptops enable users to stream audio content from cloud-based sources rather than relying on locally stored content. In a group setting, different users may want to concurrently listen to the same audio content on their respective devices. However, even if cloud-based audio content playback is started on two internet-capable digital devices at the exact same time, the audio content will generally not remain synchronized throughout playback. Factors such as network latency, decoding time, and buffering time each may contribute to the loss of synchronization of the audio content being played on the different devices. These and other factors may also contribute to frequency differences between the audio played on the different devices, thus resulting in undesirable echoes.

### SUMMARY

A computer-implemented method, non-transitory computer-readable storage medium, and audio playback device synchronizes playback of a guest audio stream with playback of a master audio stream streamed to a master device from a synchronization server. The guest device sends a request to a synchronization server to initialize a synchronized session between the guest device and the master device. The guest device receives a guest audio stream from the synchronization server and plays the guest audio stream. The guest audio stream includes a sequence of audio frames and metadata indicating frame numbers at predefined time points in the sequence of audio frames. During playback of the guest audio stream by the guest device, a guest synchronization fingerprint is inserted in the guest audio stream at predefined intervals. During playback of the guest audio stream, an ambient audio signal is recorded (e.g., using a microphone) that captures the guest audio stream and the master audio stream being concurrently played by the master device. A guest fingerprint frame time is determined at which the guest synchronization fingerprint is detected in the ambient audio signal and a master fingerprint frame time is determined at which the master synchronization fingerprint is detected in the ambient audio signal. In an embodiment, in order to extract the synchronization fingerprint from recorded audio content, the guest device applies signal processing methods to extract frequency content of the recorded signal and finds a sequence of frequency magnitude peaks that matches the synchronization fingerprints which are known by the device. A frame interval is determined between the guest fingerprint frame time and the host fingerprint frame time. A playback timing of the guest audio stream is then adjusted to reduce the frame interval between the guest fingerprint frame time and the master fingerprint frame time.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a schematic view of a communication network comprising digital devices according to an embodiment;

FIG. 2 is a flowchart illustrating a process of a master device starting a synchronized audio session according to an embodiment;

FIG. 3 is a flowchart illustrating a process of the guest device starting a synchronized audio session according to an embodiment;

FIG. 4 is a flowchart illustrating a synchronization method according to an embodiment;

FIG. 5 is a flowchart illustrating an audio track skipping method according to an embodiment;

FIG. 6 is a flowchart illustrating an audio track pausing and resuming method according to an embodiment;

FIG. 7 is a schematic block diagram of a digital device according to an embodiment;

FIG. 8 is a byte stream diagram according to an embodiment;

FIG. 9 is a flowchart illustrating a process of a synchronization algorithm according to an embodiment.

### DETAILED DESCRIPTION

The Figures (FIGS.) and the following description relate to various embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The disclosure herein provides a method and system for synchronizing playback of an internet audio stream on multiple internet-capable digital devices such as, but not limited to, smartphones, smart watches, digital music players, and tablets, without needing a local communication network between those devices, by using synchronization fingerprints, which may be in the audible frequency range (typically 20 Hz-20 kHz). The system and method also includes mechanisms to handle playback actions that are synchronized on all devices, such as skips, pauses, or simple mechanisms to handle variations in decoding speed, such as but not limited to playback interruptions (e.g. a phone call) and network disconnections. Synchronized playback of streamed audio content on multiple devices is achieved by devices compensating for time drifting induced by network instability and variable playback speed across master and guest devices to reduce the formation of echoes during playback. Additionally, the devices can recover from temporary disconnection from a cloud synchronization service to maintain synchronization.

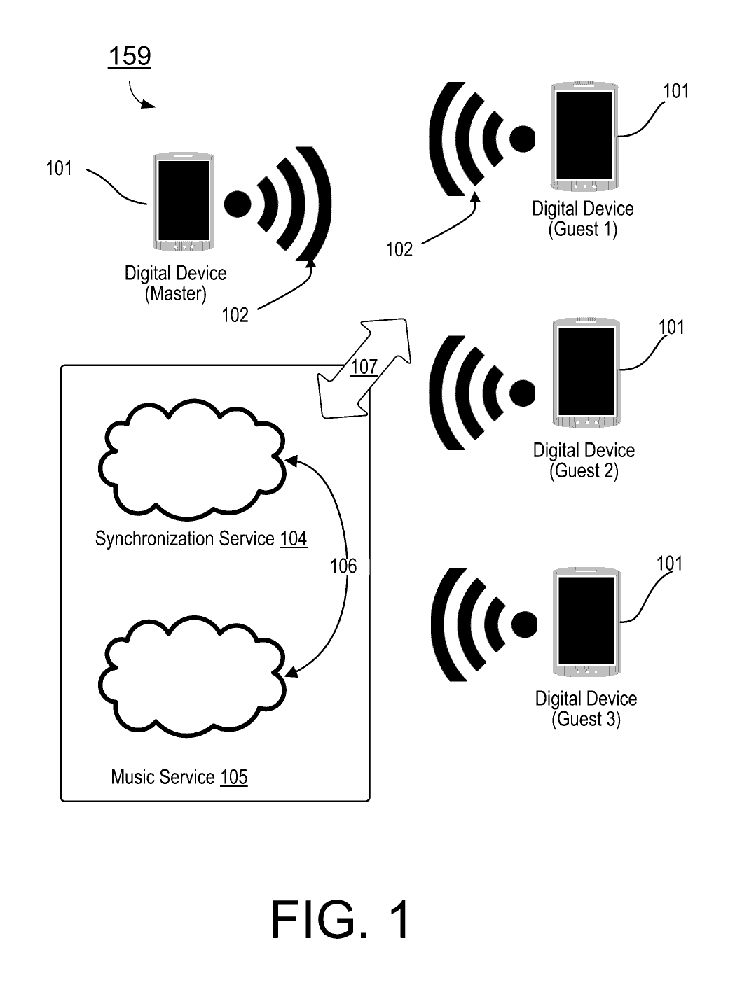

FIG. 1 is an example computing network 159 in which a plurality of digital devices 101 synchronize playback of streaming audio content. The digital devices 101 may be mobile devices having mobile phone and data management functions, such as but not limited to smartphones, smart watches, tablets, personal computers, video game consoles. The digital devices 101 may furthermore feature multimedia applications that may be factory-installed or added upon request. The digital devices 101 may be connected to audio equipment such as but not limited to Bluetooth speakers, amplifiers or sound systems. The digital devices 101 include a processor and a non-transitory computer-readable storage medium that stores instructions (e.g., one or more applications) that when executed by the processor cause the processor to carry out the functions attributed to the digital devices 101 described herein.

As shown in FIG. 1, in an embodiment, the (N+1) digital devices 101 are internet-capable and can communicate with a cloud synchronization service 104 by using an internet communication link 102 in order to form the network 159. In an embodiment, the synchronization service 104 and digital devices 101 can use a variety of communication mechanisms 107, such as HTTP streaming, the Web Socket standard or REST API endpoints. In an embodiment, the synchronization service 104 also communicates with a music service 105 through the internet through various protocols 106, such as, but not limited to, REST API endpoints. The synchronization service 104 and the music service 105 may be embodied as one or more processing devices that communicate with the digital devices 101 and with each other over a network such as the Internet. For example, in one embodiment, the synchronization service 104 and the music service 105 comprise servers, which may be separate servers or may be merged together as a single physical or logical entity. Furthermore, each of the synchronization service 104 and the music service 105 may be embodied as an application executing across multiple servers. In yet other embodiments, one or both of the synchronization service 104 and the music service 105 may operate on one or more of the digital devices 101. For example, a master device may serve music to the guest devices from its local library. The processing device(s) corresponding to the synchronization service 104 and the music service 105 each include one or more processors and a non-transitory storage medium that stores instructions (e.g., one or more applications) that when executed by the one or more processors cause the one or more processors to carry out the functions attributed to the synchronization service 104 and the music service 105 described herein.

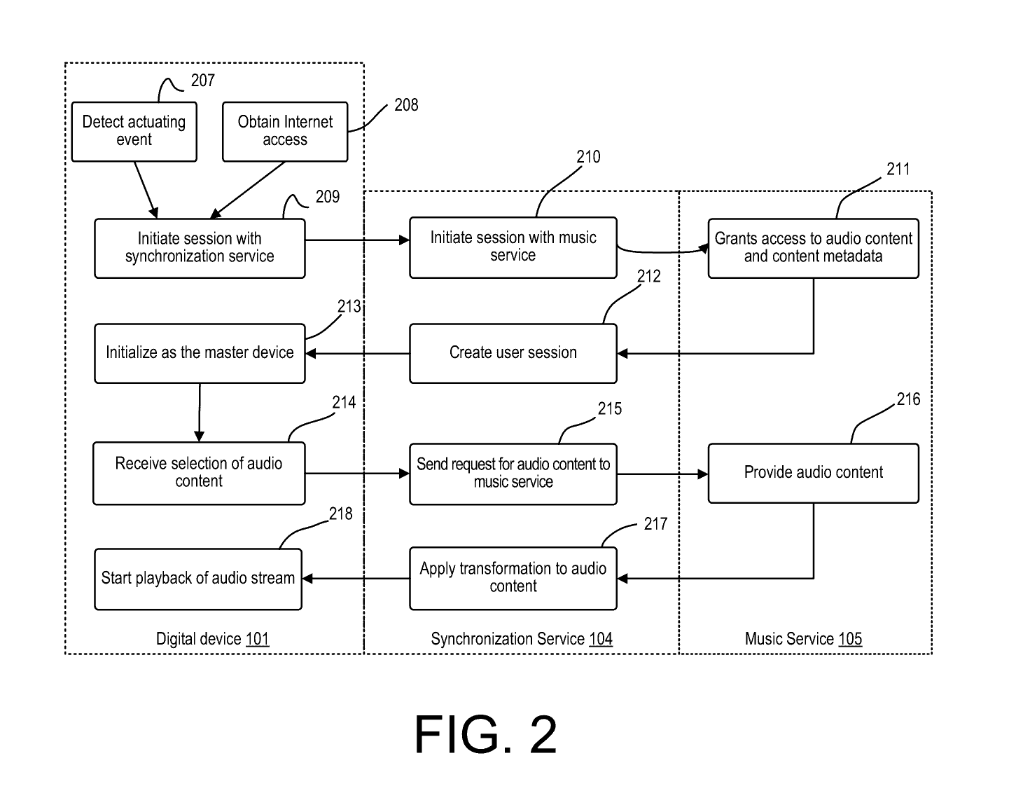

FIGS. 2-7 illustrate various processes performed by the digital devices 101, the synchronization service 104, and the music service 105.

FIG. 2 illustrates a method in which a digital device 101 initiates a synchronization session as a master device. In a preliminary step, the digital device 101 of the network 159 obtains 208 internet access, which can be achieved through transceivers such as but not limited to WiFi, 3G or LTE transceivers which can be part of or external to the device 101. In another preliminary step, the digital device 101 detects 207 an actuating event (e.g., from a user) that triggers initiation of the session.

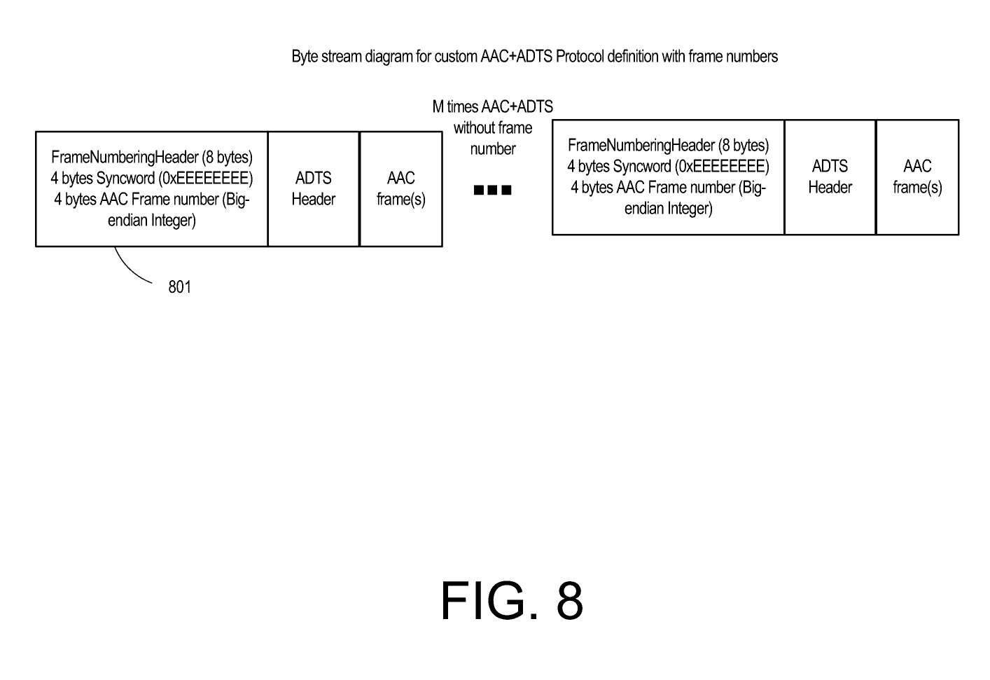

After the preliminary steps 207, 208, the digital device 101 can initiate 209 a session with the synchronization service 104 through internet communication protocols 107. In an embodiment, the synchronization service 104 obtains music service authentication information from the digital device 101 with or subsequent to the request to initiate the session and prior to the synchronization service 104 requesting data from the music service 105. Authentication information can include but is not limited to user's email, username, password, an authentication token provided by a social networking service, etc. In another embodiment, no music service authentication information is required. The synchronization service 104 initiates 210 a session with the music service 105. In an embodiment, the session is initiated with one music service 105 but in another embodiment sessions can be initiated with multiple music services 105. The music service 105 grants 211 access to audio content and metadata about the audio content to the synchronization service 104. The music service 105 may furthermore stream the audio content and metadata to the synchronization service 104. At step 212, the synchronization service 104 creates a user session and provides session information to digital device 101. The digital device 101 initializes 213 itself as a master device. The digital device 101 receives 214 a selection of audio content (e.g., via a user input) to be played. In an embodiment, audio content can be, while not being limited to, a single audio track or a series of audio tracks in specific or random ordering. In an embodiment, a user can search for available audio content offered by the music service 105 via the digital device 101. In another embodiment, available audio content can be presented on the digital device 101 to the user without the user needing to enter a search query. Upon selection by the user, the synchronization service 104 sends 215 the request for the audio content to the music service 105. Upon receiving the request, the music service 105 provides 216 the content to the synchronization service 104. In an embodiment, each audio track can be provided by music service 105 when needed by digital device 101 through a request by synchronization service 104. In another embodiment the music service 105 can provide one or multiple audio tracks for future use by the digital device 101 or the synchronization service 104. In an embodiment, the synchronization service 104 applies 217 transformations to audio content and creates an audio stream. The transformation can include adding frame number metadata to the audio content. For example, the audio stream may be divided into equal duration audio frames and metadata is added between each M frames to indicate the number of the following frame of the stream. An example of frame metadata is discussed in further detail below with respect to FIG. 8. Additionally, transformations can include, for example, a file format change, an encoding format change, or a bit rate change. In an embodiment, the transformation may furthermore include replacing audio content received from the music service 105 with silent data having the same frame structure, file format, bit rate, etc. as the music content. Silent data may be used as a transition between operations such as skipping ahead, pausing playback, or other operations described in further detail below, and enables the devices 101 to maintain synchronization during these operations. The digital device 101 receives the audio stream and starts 218 playback of the audio content.

In an alternative embodiment, step 209 and 214 are merged so that a session is only created by the synchronization service 104 after the user has selected audio content.

In an embodiment, N other devices may join the same session and become guest devices using the process of FIG. 2. Furthermore, during synchronized playback, a guest device may temporarily become a master device to allow additional guest devices to be synchronized to it in the manner described above.

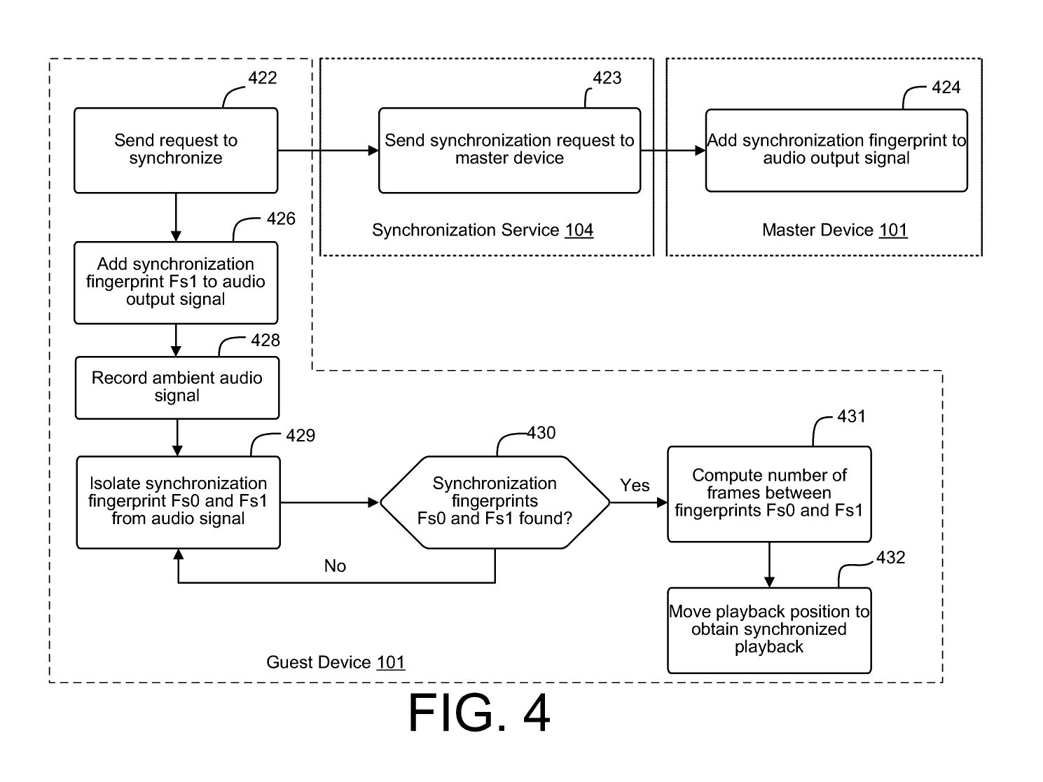

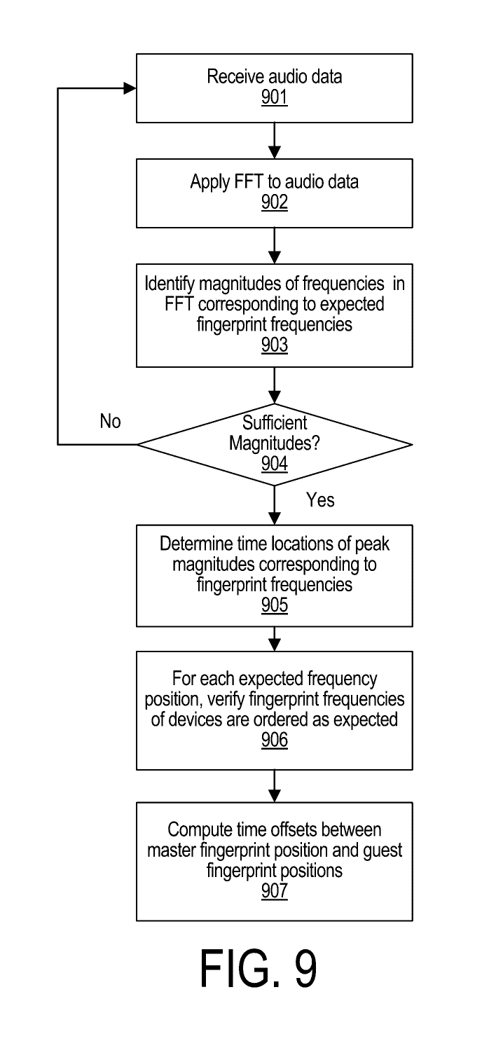

FIG. 8 is a byte stream diagram showing a byte format for the streaming audio according to a modified AAC+ADTS custom protocol. A frame numbering header 801 is added to the regular AAC+ADTS custom protocol. The header is added before each M ADTS header. When a session is created and synchronization service starts sending an audio stream, the frame numbering is continually incremented regardless of whether music content or silent content is being played. The frame numbering is used to add synchronization fingerprints to the audio content by the master device and the synchronizing guest at specific frames numbers (e.g. each multiple of 5 frames) during the synchronization process of FIG. 4 described below. Furthermore, the frame numbers are used in the synchronization algorithm (described in FIG. 9) to compute the difference between playback position of the master and the synchronizing guest device, and therefore move the playback position of the guest device in order to achieve synchronized playback. In one embodiment, AAC+ADTS custom protocol is used to encode the audio stream. In another embodiment, another encoding format allowing frame-numbering metadata is used. In one embodiment, frame-numbering metadata is added to the audio stream by the synchronization service 104. In another embodiment, frame-numbering metadata is added by the digital device 101.

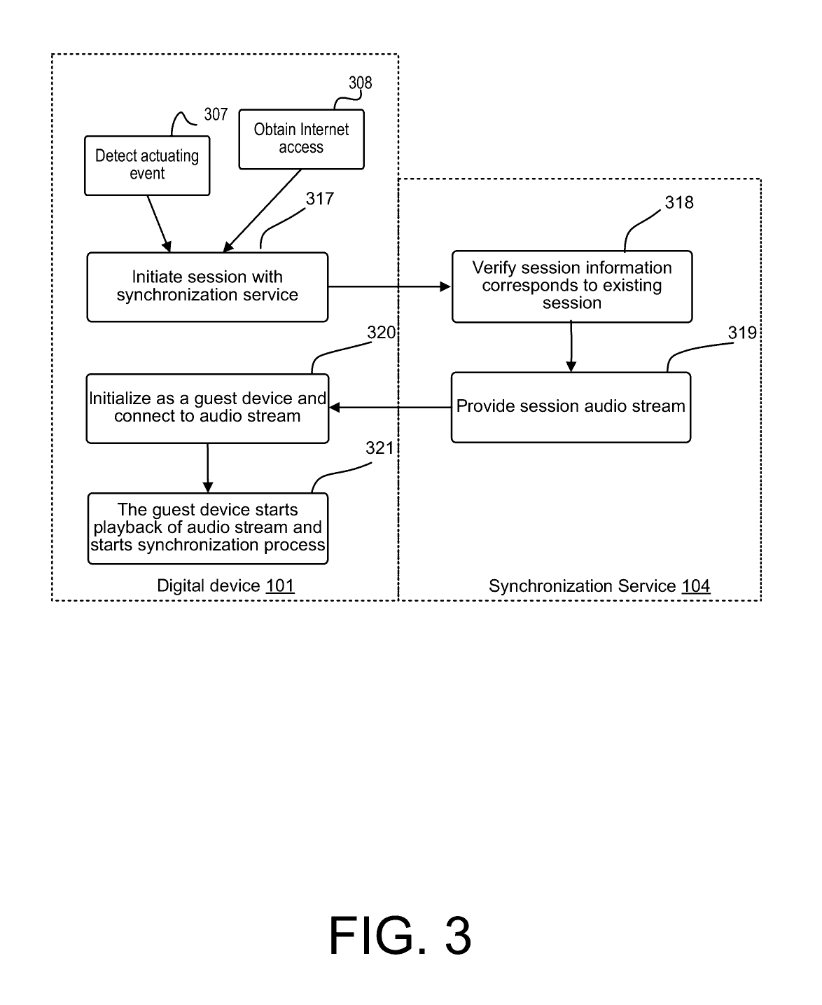

FIG. 3 is a flowchart illustrating an embodiment of a process for initiating a synchronization session by a digital device 101 operating a guest device. In a preliminary step, the digital device 101 of the network 159 obtains 308 internet access, which can be achieved through transceivers such as but not limited to WiFi, 3G or LTE transceivers which can be part of or external to the device. In another preliminary step, the digital device 101 detects 307 an actuating event (e.g., a user input) that triggers the initiation of the session. The digital device 101 initiates 317 a session with the synchronization service 104 through the internet communication protocols 107. In one embodiment, no music service authentication information is required. In other embodiments, the synchronization service 104 obtains music service authentication information from the digital device 101 prior to requesting data from music service 105. If authentication information is used, the digital device 101 receives a session identifier (e.g., as an automatically generated identifier which may optionally be based on a user input) when initiating the session. The session identifier may comprise a unique number. In other embodiments, the session identifier may be comprise, for example, a QR code or GPS-provided geolocalization or proximity data obtained by Bluetooth or other means. The synchronization service 104 verifies 318 in a database that the provided session information corresponds to an existing session. If the session exists, the synchronization service 104 provides 319 the session stream including the frame numbering metadata. The digital device 101 is initialized 320 as a guest device and the digital device 101 connects to the provided audio stream. The audio stream is the same audio stream that is provided to the digital device 101 operating as the master device and which initiated the corresponding session (as shown in the process of FIG. 2). The digital device 101 starts 321 playback of the audio content upon receiving it. The process of FIG. 3 may be performed by (N+1) guest devices that join a session hosted by a master device.

In an embodiment, the master device (that initializes a session according to the process of FIG. 2) and the (N+1) guest devices (that join respective sessions according to the process of FIG. 3) are connected to receive the same audio stream. The audio stream is throttled by the synchronization service 104 in order to ensure that any of the (N+1) guest digital devices 101 joining the session at any time during the session will start receiving the audio stream at approximately at the same playback position as the master device or the other N guest devices. This guarantees that the playback position at any given time on the master device and the (N+1) guest devices is at worst only a few audio frames apart. However, the respective playback positions may not be exactly synchronized among devices because of delays induced by each device's internet connection quality, decoding time, playback rate, or other factors. In order to obtain synchronized playback among master and all guest devices, a synchronization process shown by FIG. 4 is applied, as will be described below.

In another embodiment, the synchronization service 104 provides multiple audio streams, one for the master device and one for each of the (N+1) guest devices and the synchronization service 104 ensures that those streams are sending the same audio frames at the same time. In another embodiment, audio content is not streamed but rather downloaded in chunks of data by each device and the synchronization service sends to the master device and the (N+1) guest devices a timeline that indicates what audio frame devices should be playing with respect to a central clock.

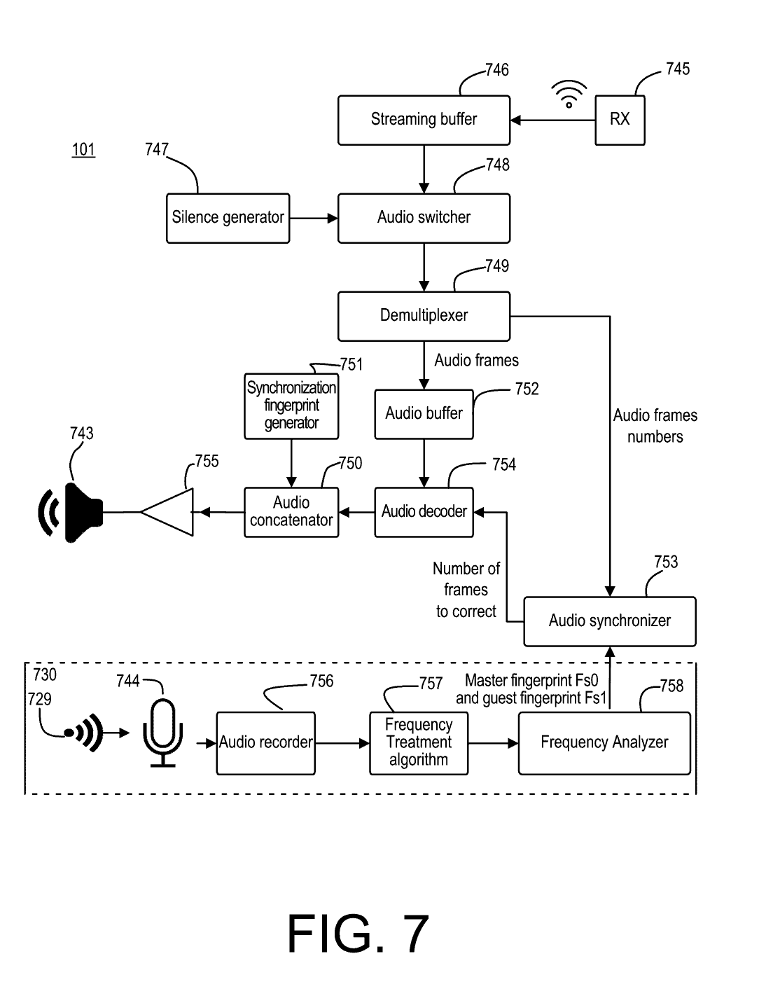

FIG. 4 is a high-level synchronization process for synchronizing streaming audio content played by a guest device with streaming audio content played by a master device during a playback session joined by both devices. The guest device sends a request to synchronize to the synchronization service 104. The synchronization service 104 receives the request and sends 423 the synchronization request to the master device to notify it that a guest is joining the session. In an embodiment, any digital device 101 that is part of a same session can temporarily become the master device for the purpose allowing a guest device to synchronize audio playback with said master device. Upon receiving the synchronization request, the master device adds 424 a synchronization fingerprint Fs0 to its output audio signal (e.g., as will be described in FIG. 7 below). Meanwhile, the guest device also adds 426 a synchronization fingerprint Fs1 to its output audio. In an embodiment, the guest device and the master device each add respective fingerprints to the audio at the same specific frame numbers and then repeat the fingerprint at each N frames where N is positive integer. In one embodiment, the synchronization fingerprints Fs0 and Fs1 have a different base frequency which is provided by the synchronization service 104 to the master device and the guest device respectively. The synchronization process of FIG. 4 can be performed with multiple guest devices at the same time. In this scenario, the synchronization fingerprint added by each guest device can have a different base frequency in order to have a different fingerprint Fs1 to FsN for each guest device, which may each be added at the same frame numbers. The particular base frequencies are determined based on instructions from the synchronization service 104. In one embodiment, the base frequency of each synchronization fingerprint is in the audible frequency range. In another embodiment, the base frequency can be outside of the audible frequency range. In yet another embodiment, the base frequency of the synchronization fingerprint can be dynamically adapted by the master device and the guest devices. The fingerprints Fs0 and Fs1 may each comprise a pattern of tones of predefined timing and length. In an embodiment, the guest device records 428 an ambient audio during playback of the streamed audio by the guest device and the master device. The guest device then isolates 429 synchronization fingerprints Fs0 and Fs1 from the audio signal by using an audio processing algorithm described in further detail below with reference to FIG. 9. For example, in one embodiment, a guest fingerprint frame time is determined corresponding to a frame time at which the guest synchronization fingerprint Fs1 is detected, and a master fingerprint frame time is determined corresponding to a frame time at which the master synchronization fingerprint Fs0 is detected. If the synchronization fingerprints Fs0 and Fs1 cannot be found in step 430, the process returns to step 429 to attempt again to isolate the fingerprints. If both of the synchronization fingerprints Fs0 and Fs1 are found in step 430, the guest device computes 431 the number of audio frames between the fingerprints to determine a frame interval between the guest fingerprint frame time and the host fingerprint frame time. Since the synchronization fingerprints are added by the master and guest devices at specific frame numbers, the same for both devices, and repeated at each N frames where N is positive integer, the synchronization process can correct a playback offset of up to N/2 frames forward or N/2 frames backward, and a minimal offset of 1 frame. In one embodiment, the length of 1 frame is selected in order to prevent the formation of audible echo, which would not be considered as synchronized playback to a human ear. In an embodiment, N is selected so that N/2 is the expected maximum offset of the guest device initial playback position when compared with the master device playback position, both being connected to the same audio stream. The guest device moves 432 its playback position of the audio stream by the number of frames computed at step 431 (e.g., by adjusting its audio buffer) in order to reduce the frame interval and obtain synchronized playback with the master device, provided that both the master device and the guest device fill their audio buffer with N frames before starting playback at and that the initial playback position is N/2 for all devices. In an embodiment, the devices 101 each include a sufficient playback buffer on said devices to allow repositioning of the playback. For example, since devices 101 all play the same stream, the playback offset between the devices 101 may be a few seconds. In an embodiment, playback speed on the devices may also be adjusted in order to make finer adjustments to improve synchronization.

In an embodiment, once synchronization is achieved, the guest device may stop adding the synchronization fingerprint Fs1 to its audio content and may send a message to the synchronization service 104 to let the synchronization service 104 know that the synchronization process is completed. The synchronization service 104 then sends a message to the master device to stop adding the synchronization fingerprint Fs0 to its audio content.

In one embodiment, any guest device can act as a temporary master device to perform the synchronization process of FIG. 4 with another guest device. Here, a base frequency P is used for the synchronization fingerprint of the temporary master device, where P and N are provided by the synchronization service 104.

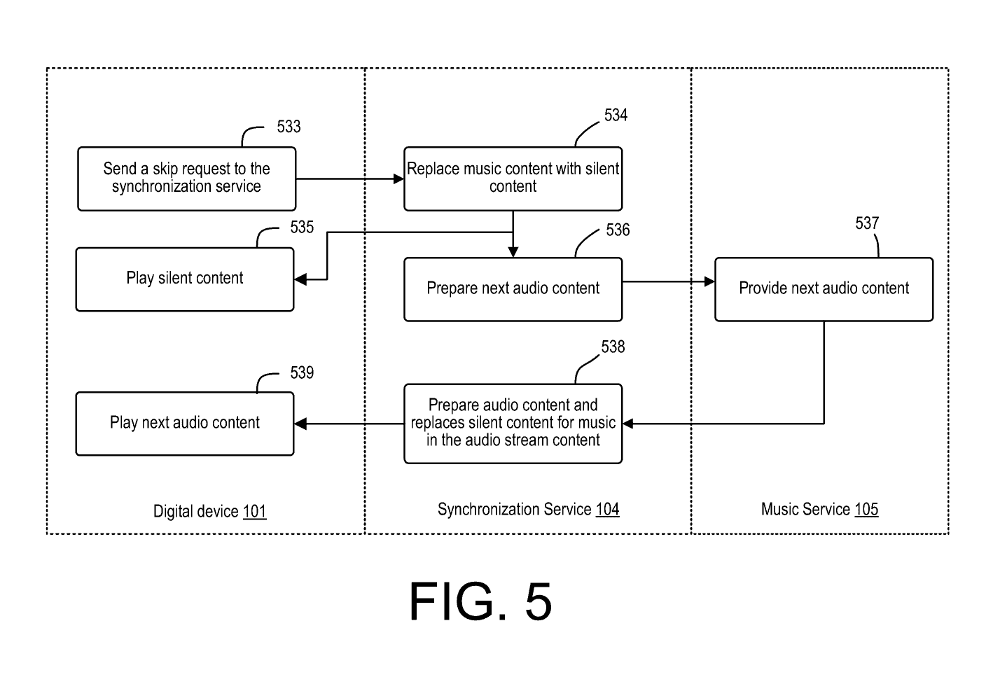

FIG. 5 is a flowchart illustrating a process of skipping an audio track while keeping all digital devices 101 of the session synchronized. In an embodiment, the digital device 101 (which may be a master device or a guest device) receives a user request to skip to a next track and sends 533 a skip request to the synchronization service 4 in response to the user action. Upon receiving the skip request from the digital device 101, the synchronization service 104 replaces 534 content in the audio stream in the current audio track with silent audio content that has the same amount of data per frame as the current audio track and provides the silent audio content to each of the digital devices 101 in the session in place of the requested audio content. This silent audio content is played 535 by each of the digital devices 101 in the same manner that they play audio content. Frame numbering metadata is also added to the silent content in order to preserve frame-numbering continuity during the entire session. This allows connected digital devices 101 to remain synchronized while the synchronization service 104 prepares the next audio track. In another embodiment, synchronization service 104 does not send silent content to connected devices and simply keeps sending the current audio content until next audio track is ready to be sent. In another embodiment, audio content is replaced by silent content by the digital devices 101 instead of by the synchronization service 104. In another embodiment, playback is paused by the digital devices 101 at the same frame number instructed by the synchronization service 104 and resumed at the same time and at the same frame number, as instructed by the synchronization service 104. The synchronization service 104 prepares 536 the next audio track from music service 105. The music server 105 provides 537 the next audio track to the synchronization service 104. The synchronization service 104 then prepares 538 the audio content (e.g., by converting the audio track to the proper format and adding frame numbering metadata as described above), and replaces the silent content with the music in the next audio track. In another embodiment, one or more tracks are gathered and prepared in advance by the synchronization service 104. The synchronization service 104 provides the next track to the synchronized digital devices 101. The digital devices 101 receive and play 539 the audio stream corresponding to the next track while continuing to maintain synchronization.

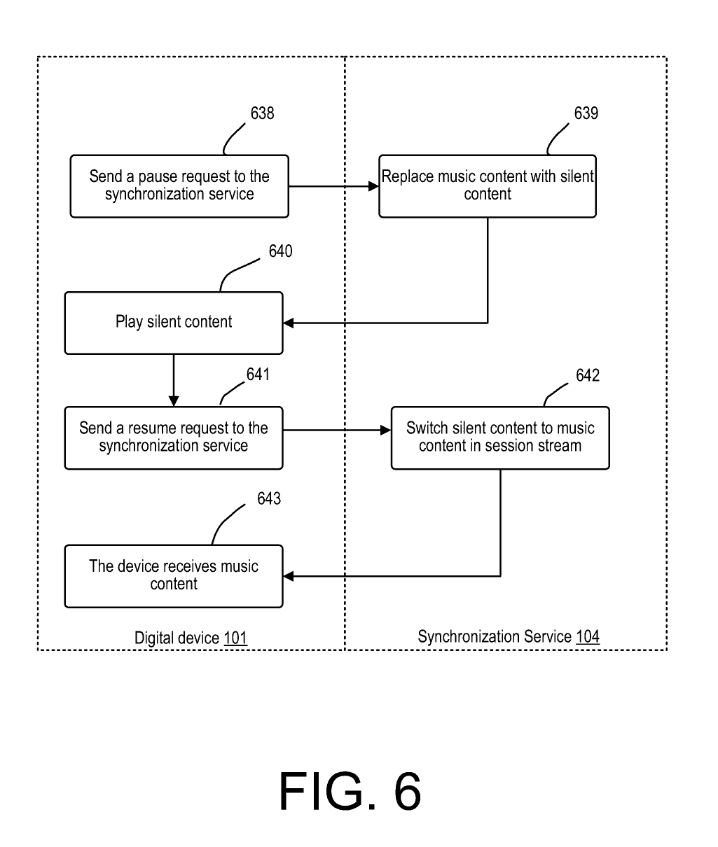

FIG. 6 is a flowchart illustrating an embodiment of a process for pausing an audio track while keeping all digital devices 101 of the session synchronized. In an embodiment, the digital device 101 (which may be a master device or a guest device) sends 638 a pause request to the synchronization service 104 (e.g. in response to a user request). The digital device 101 may furthermore store a pause frame number associated with the audio stream at the time of sending the request. Upon receiving the pause request from the digital device 101, the synchronization service 104 replaces content in the current audio track with silent audio content that has the same amount of data per frame as the current audio content. The digital device 101 plays 640 the silent content from the session audio stream. This allows connected digital devices 101 to remain synchronized while the synchronization service 104 waits for a resume request from the master device. Frame numbering metadata is also added to the silent content in order to preserve frame-numbering continuity during the entire session. In another embodiment, the synchronization service 104 does not send silent content to connected devices 101 and simply keeps sending the current audio content until next audio track is ready to be sent. In another embodiment, audio content is replaced by silent content by the digital devices 101. In another embodiment, playback is paused by the digital devices 101 at the same frame number instructed by the synchronization service 104 and resumed at the same time and at the same frame number, as instructed by the synchronization service 104. In the embodiment, the digital device 101 sends 641 a resume request to the synchronization service (e.g., in response to a user input to resume playback). In another embodiment, the resume request can be sent by a different device in the session. The synchronization service 104 switches 642 the silent content with the audio track that was being streamed previously, and resumes playback at the frame that was being played when synchronization service 104 received the pause request. The digital device 101 receives 643 and plays the music content contained in the audio stream beginning at the pause frame number.

FIG. 7 shows a high-level block diagram of an example digital device 101. A receiver 745 receives data (e.g., audio content) used by the digital device 101. The receiver 745 may receive data from the internet using networks such as 3G, LTE or Wifi networks. Audio content received from the synchronization service 104 is stored temporarily in a streaming buffer 746. The audio switcher 748 selects between data received from the streaming buffer 746 and data received from the silence generator 747. In situations where network events (e.g. latency, disconnection, etc) would cause the streaming buffer 746 to be empty, the silence generator 747 provides silent audio frames and provides continuity to the frame numbering of the stream provided by the synchronization service 104 in order to keep the devices synchronized. The silence generator 747 is also used to provide silent data during pause and skip operations as described above. In an embodiment, the data stream from audio switcher 748 is provided to the demutliplexer 749. The demultiplexer 749 separates the frame numbers contained in the stream's metadata from the actual audio content. In an embodiment, audio frames are then sent to the audio buffer 752 which temporarily stores the frames and provides frames to the audio decoder 754 to decode the audio. In an embodiment, the decoded audio frames are then sent to an audio concatenator 750. The audio concatenator 750 concatenates the decoded audio frames with a fingerprint (e.g., Fs0, FsN, or FsP) generated by the synchronization fingerprint generator 751. The result of the concatenation is then sent to the amplifier 755 which amplifies the audio signal. The amplifier 755 provides the amplified signal to the device speakers 743 to generate the ambient audio output. In an embodiment, during the synchronization process described above, an audio recorder 756 of a guest digital device 101 records the resulting ambient audio signal 729 which contains the guest device synchronization fingerprint Fs1 or FsN and the master device synchronization fingerprint Fs0 or FsP using the guest device microphone 744. In an embodiment, a fingerprint identification algorithm (detailed in FIG. 9 below) is applied by a frequency treatment algorithm module 757, a frequency analyzer 758, and an audio synchronizer 753. Particularly, the frequency treatment algorithm module 757 transforms the recorded audio into frequency data which is processed by the frequency analyzer 758 to identify the frequencies. The frequency analyzer 758 then finds the master and the guest device synchronization fingerprints through the frequency data. The audio synchronizer 753 computes the number of audio frames between both fingerprints. The audio synchronizer 753 can therefore move the audio frames of the audio decoder 754 forward or backward until both fingerprints are detected to be at the same position in the recorded audio by the audio synchronizer 753.

FIG. 9 is a flowchart illustrating an algorithm for processing the audio signal to extract the fingerprints as performed by the frequency treatment algorithm 757 and the frequency analyzer 758. In an embodiment, the audio data (e.g., a byte array with a size 4096) is received 901 from the microphone of the guest device at step and then a time-to-frequency domain transformation (e.g., a complex forward transformation) is applied 902 on each sample to generate a sequence of frequency domain samples. For example, in one embodiment a Fast Fourier Transform (FFT) may be applied. The magnitudes of the frequencies corresponding to the expected frequencies of the synchronization fingerprint Fs0, Fs1, FsN or FsP are identified 903 in the sequence of frequency domain samples. Steps 901-903 are repeated until it is determined 904 that sufficient magnitudes of each expected frequency of the expected synchronization fingerprints are found within a predefined time period (e.g., 1 second). Once the criteria is met 904, it is detected 905 where the time locations of the peak magnitudes are corresponding to each of the different fingerprint frequencies (i.e., where in the recorded audio each of the different fingerprint frequencies are detected as being strongest). When an expected frequency position is found, other frequencies of the synchronization fingerprint are retrieved and the algorithm verifies 906 that those frequencies are ordered as the expected synchronization fingerprint defines it. For example, a pattern of peak magnitude locations matching a known pattern corresponding to the guest synchronization fingerprint may be located and a pattern of peak magnitude locations matching a known pattern corresponding to the master synchronization fingerprint may be located. Once the master fingerprint frame time corresponding to a position of the synchronization fingerprint of the master device Fs0 or of the guest device acting as a master device FsP, and the guest fingerprint frame time corresponding to a position of the synchronization fingerprint of the guest device Fs1 or FsN are found and verified, the audio synchronizer 753 computes 907 the offset (e.g., a frame interval) between both fingerprints in terms of audio frames as described above. The playback position of the guest device can then be modified by the audio decoder 754 as described above in order to achieve synchronized playback. In another embodiment, variations of this algorithm or other algorithms can be used in order to compute the offset between the master device synchronization fingerprint and the guest device synchronization fingerprint.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for the embodiments herein through the disclosed principles. Thus, while particular embodiments and applications have been illustrated and described, it is to be understood that the disclosed embodiments are not limited to the precise construction and components disclosed herein. Various apparent modifications, changes, and variations may be made in the arrangement, operation and details of the method and apparatus disclosed herein without departing from the scope defined in the appended claims.

1. A computer-implemented method for synchronizing playback of a guest audio stream streamed to a guest device from a synchronization server with playback of a master audio stream streamed to a master device from the synchronization server, the method comprising:
sending, by the guest device, a request to a synchronization server to initialize a synchronized session between the guest device and the master device;
receiving, by the guest device, the guest audio stream from the synchronization server, the guest audio stream including a sequence of audio frames and metadata indicating frame numbers at predefined time points in the sequence of audio frames;
beginning playback of the guest audio stream;
during playback of the guest audio stream by the guest device, inserting a guest synchronization fingerprint at predefined frame intervals in the guest audio stream;
during playback of the guest audio stream by the guest device, recording an ambient audio signal that captures the guest audio stream and the master audio stream being concurrently played by the master device;
determining a guest fingerprint frame time at which the guest synchronization fingerprint is detected in the ambient audio signal and detecting a master fingerprint frame time at which the master synchronization fingerprint is detected in the ambient audio signal;
determining a frame interval between the guest fingerprint frame time and the host fingerprint frame time; and
adjusting a playback timing of the guest audio stream to reduce the frame interval between the guest fingerprint frame time and the master fingerprint frame time.

2. The computer-implemented method of claim 1, wherein detecting the guest fingerprint frame time and the host fingerprint frame time comprises:
applying a time-to-frequency domain transformation to each of a sequence of samples of the recorded ambient audio signal to generate a sequence of frequency-domain samples;
detecting peak magnitude locations where peak magnitudes of frequencies corresponding to the guest synchronization fingerprint and the master synchronization fingerprint occur in the sequence of frequency-domain samples;
locating in the sequence of samples, a first pattern of the peak magnitude locations that match a known pattern of frequencies of the guest synchronization fingerprint; and
determining the guest fingerprint frame time corresponding to a time location of the first pattern;
locating in the sequence of samples, a second pattern of the peak magnitude locations that match a known pattern of frequencies of the master synchronization fingerprint;
determining the master fingerprint frame time corresponding to a time location of the second pattern.

3. The computer-implemented method of claim 1, further comprising:
receiving, during playback of the guest audio stream, a request to skip to a next track;
sending to the synchronization server, a skip track request;
receiving, in response to the skip track request, a silent audio stream comprising audio frames representing silence;
playing the silent audio stream while the synchronization server prepares the next track;
receiving a guest audio stream corresponding to the next track; and
playing the guest audio stream corresponding to the next track.

4. The method of claim 3, wherein the silent audio stream comprises a same frame structure as the guest audio stream.

5. The computer-implemented method of claim 1, further comprising:
receiving, during playback of the guest audio stream, a request to pause the guest audio stream;
sending to the synchronization server, a pause request;
storing a pause frame number associated with the guest audio stream at the time of receiving the user request to pause the audio stream;
receiving, in response to the pause request, a silent audio stream comprising audio frames representing silence;
playing the silent audio stream;
receiving, during playback of the silent audio stream, a request to resume the guest audio stream; and
resuming playback of the guest audio stream beginning at the pause frame number.

6. The method of claim 1, wherein adjusting the playback timing of the guest audio stream comprises:
moving a playback position of the guest audio stream by a number of frames corresponding to the frame interval between the guest fingerprint frame time and the master fingerprint frame time.

7. The method of claim 1, further comprising:
temporarily configuring the guest device as a temporary master device; and
receiving a synchronization request from a third device; and
modifying the guest audio stream to include temporary master fingerprints for synchronizing the third device to the guest device configured as a temporary master device.

8. A non-transitory computer-readable storage medium storing instructions for synchronizing playback of a guest audio stream streamed to a guest device from a synchronization server with playback of a master audio stream streamed to a master device from the synchronization server, the instructions when executed by a processor causing the processor to perform steps including:
sending a request to a synchronization server to initialize a synchronized session between the guest device and the master device;
receiving the guest audio stream from the synchronization server, the guest audio stream including a sequence of audio frames and metadata indicating frame numbers at predefined time points in the sequence of audio frames;
beginning playback of the guest audio stream;
during playback of the guest audio stream by the guest device, inserting a guest synchronization fingerprint at predefined frame intervals in the guest audio stream;
during playback of the guest audio stream by the guest device, recording an ambient audio signal that captures the guest audio stream and the master audio stream being concurrently played by the master device;
determining a guest fingerprint frame time at which the guest synchronization fingerprint is detected in the ambient audio signal and detecting a master fingerprint frame time at which the master synchronization fingerprint is detected in the ambient audio signal;
determining a frame interval between the guest fingerprint frame time and the host fingerprint frame time; and
adjusting a playback timing of the guest audio stream to reduce the frame interval between the guest fingerprint frame time and the master fingerprint frame time.

9. The non-transitory computer-readable storage medium of claim 8, wherein detecting the guest fingerprint frame time and the host fingerprint frame time comprises:
applying a time-to-frequency domain transformation to each of a sequence of samples of the recorded ambient audio signal to generate a sequence of frequency-domain samples;
detecting peak magnitude locations where peak magnitudes of frequencies corresponding to the guest synchronization fingerprint and the master synchronization fingerprint occur in the sequence of frequency-domain samples;
locating in the sequence of samples, a first pattern of the peak magnitude locations that match a known pattern of frequencies of the guest synchronization fingerprint; and
determining the guest fingerprint frame time corresponding to a time location of the first pattern;
locating in the sequence of samples, a second pattern of the peak magnitude locations that match a known pattern of frequencies of the master synchronization fingerprint;
determining the master fingerprint frame time corresponding to a time location of the second pattern.

10. The non-transitory computer-readable storage medium of claim 8, wherein the instructions when executed further cause the processor to perform steps including:
receiving, during playback of the guest audio stream, a request to skip to a next track;
sending to the synchronization server, a skip track request;
receiving, in response to the skip track request, a silent audio stream comprising audio frames representing silence;
playing the silent audio stream while the synchronization server prepares the next track;
receiving a guest audio stream corresponding to the next track; and
playing the guest audio stream corresponding to the next track.

11. The non-transitory computer-readable storage medium of claim 10, wherein the silent audio stream comprises a same frame structure as the guest audio stream.

12. The non-transitory computer-readable storage medium of claim 8, wherein the instructions when executed further cause the processor to perform steps including:
receiving, during playback of the guest audio stream, a request to pause the guest audio stream;
sending to the synchronization server, a pause request;
storing a pause frame number associated with the guest audio stream at the time of receiving the user request to pause the audio stream;
receiving, in response to the pause request, a silent audio stream comprising audio frames representing silence;
playing the silent audio stream;
receiving, during playback of the silent audio stream, a request to resume the guest audio stream; and
resuming playback of the guest audio stream beginning at the pause frame number.

13. The non-transitory computer-readable storage medium of claim 8, wherein adjusting the playback timing of the guest audio stream comprises:
moving a playback position of the guest audio stream by a number of frames corresponding to the frame interval between the guest fingerprint frame time and the master fingerprint frame time.

14. The non-transitory computer-readable storage medium of claim 8, further comprising:
temporarily configuring the guest device as a temporary master device; and
receiving a synchronization request from a third device; and
modifying the guest audio stream to include temporary master fingerprints for synchronizing the third device to the guest device configured as a temporary master device.

15. An audio playback device, comprising:
a processor; and
a non-transitory computer-readable storage medium storing instructions for synchronizing playback of a guest audio stream streamed to a guest device from a synchronization server with playback of a master audio stream streamed to a master device from the synchronization server, the instructions when executed by the processor causing the processor to perform steps including:
sending a request to a synchronization server to initialize a synchronized session between the guest device and the master device;
receiving the guest audio stream from the synchronization server, the guest audio stream including a sequence of audio frames and metadata indicating frame numbers at predefined time points in the sequence of audio frames;
beginning playback of the guest audio stream;
during playback of the guest audio stream by the guest device, inserting a guest synchronization fingerprint at predefined frame intervals in the guest audio stream;
during playback of the guest audio stream by the guest device, recording an ambient audio signal that captures the guest audio stream and the master audio stream being concurrently played by the master device;
determining a guest fingerprint frame time at which the guest synchronization fingerprint is detected in the ambient audio signal and detecting a master fingerprint frame time at which the master synchronization fingerprint is detected in the ambient audio signal;
determining a frame interval between the guest fingerprint frame time and the host fingerprint frame time; and
adjusting a playback timing of the guest audio stream to reduce the frame interval between the guest fingerprint frame time and the master fingerprint frame time.

16. The audio playback device of claim 15, wherein detecting the guest fingerprint frame time and the host fingerprint frame time comprises:
applying a time-to-frequency domain transformation to each of a sequence of samples of the recorded ambient audio signal to generate a sequence of frequency-domain samples;
detecting peak magnitude locations where peak magnitudes of frequencies corresponding to the guest synchronization fingerprint and the master synchronization fingerprint occur in the sequence of frequency-domain samples;
locating in the sequence of samples, a first pattern of the peak magnitude locations that match a known pattern of frequencies of the guest synchronization fingerprint; and
determining the guest fingerprint frame time corresponding to a time location of the first pattern;
locating in the sequence of samples, a second pattern of the peak magnitude locations that match a known pattern of frequencies of the master synchronization fingerprint;
determining the master fingerprint frame time corresponding to a time location of the second pattern.

17. The audio playback device of claim 15, wherein the instructions when executed further cause the processor to perform steps including:
receiving, during playback of the guest audio stream, a request to skip to a next track;
sending to the synchronization server, a skip track request;
receiving, in response to the skip track request, a silent audio stream comprising audio frames representing silence;
playing the silent audio stream while the synchronization server prepares the next track;
receiving a guest audio stream corresponding to the next track; and
playing the guest audio stream corresponding to the next track.

18. The audio playback device of claim 15, wherein the instructions when executed further cause the processor to perform steps including:
receiving, during playback of the guest audio stream, a request to pause the guest audio stream;
sending to the synchronization server, a pause request;
storing a pause frame number associated with the guest audio stream at the time of receiving the user request to pause the audio stream;
receiving, in response to the pause request, a silent audio stream comprising audio frames representing silence;
playing the silent audio stream;
receiving, during playback of the silent audio stream, a request to resume the guest audio stream; and
resuming playback of the guest audio stream beginning at the pause frame number.

19. The audio playback device of claim 15, wherein adjusting the playback timing of the guest audio stream comprises:
moving a playback position of the guest audio stream by a number of frames corresponding to the frame interval between the guest fingerprint frame time and the master fingerprint frame time.

20. The audio playback device of claim 15, further comprising:
temporarily configuring the guest device as a temporary master device; and
receiving a synchronization request from a third device; and
modifying the guest audio stream to include temporary master fingerprints for synchronizing the third device to the guest device configured as a temporary master device.
